(19) United States
(12) Patent Application Publication
(10) Pub. No.: US 2015/0310594 A1
(43) Pub. Date: Oct. 29, 2015

(54) METHOD FOR IMAGING PROCESSING, AND IMAGE PROCESSING DEVICE

(71) Applicant: FLIR SYSTEMS AB, Täby (SE)

(72) Inventor: Stefan Olsson, Stockholm (SE)

(21) Appl. No.: 14/650,550

(22) PCT Filed: Dec. 9, 2013
(86) PCT No.: PCT/SE2013/000189

§ 371 Date: Jun. 8, 2015

(30) Foreign Application Priority Data
Dec. 11, 2012 (SE) 1230148-7

(51) Int. Cl. G06T 5/00; G06T 5/50; H04N 5/365; G06T 5/20

(52) U.S. Cl. CPC G06T 5/002; G06T 5/20; G06T 5/50; H04N 5/365; G06T 2207/10016; G06T 2207/20216; G06T 2207/20182

(57) ABSTRACT

The invention relates to an image processing method and device for removing high-frequency fixed pattern noise from a video sequence, wherein a sequence of incoming frames is saved when the relevant scene moves across the detector of a provided camera and a cumulative image of fixed pattern noise is formed from the saved image sequence and wherein an average is formed (4) from the sequence of incoming saved frames. The device is also capable of removing slowly varying spatio-temporal fixed pattern noise. This is achieved by a method comprising the steps of: (a) spatially high-pass filtering the formed average (7); (b) weighting the spatially high-pass filtered average pixel by pixel temporally with a metric of the difference between incoming saved frames (5, 8, 14); (c) weighting the spatially high-pass filtered average with the value of an edge metric of incoming saved frames (6, 9, 15); (d) storing (11) the weighted, spatially high-pass filtered average and subtracting (20) it from the video sequence.

### FIELD OF THE INVENTION

The present invention relates to an image processing method for removing high-frequency fixed pattern noise from a video sequence, wherein a sequence of incoming frames is saved when the relevant scene moves across the detector of a provided camera and a cumulative image of fixed pattern noise is formed from the saved image sequence, and wherein an average is formed from the sequence of incoming saved frames. The invention also relates to an image processing device for implementing the image processing method.

### BACKGROUND

Interference in the form of fixed pattern noise (FPN) is a major problem in many contexts, particularly in the infrared range. The noise is more visible in uncooled systems than in cooled systems. Under severe conditions, however, the fixed pattern noise can be just as disturbing even in cooled systems.

Previous solutions to the problem with this type of noise have generally focused on various types of digital filters. However, it has proven difficult to find a filter that effectively removes the noise without removing scene details and without creating annoying artefacts and shadow effects.

Another solution to the problem, one that is based on a basic principle similar to the present invention, was proposed in US 2012/0113299 A1, according to which frames are saved when there is relative motion between the current frame and a previous one. An averaging operation is performed on the pixel values of the frames to determine an average for each pixel of a reference image, whereupon corrective terms are determined for each pixel of the current frame by determining the difference between the current pixel values of the frame and the corresponding pixels of the reference image, and correcting the current frame using the correction terms.

### SUMMARY OF THE INVENTION

The purpose of the invention is to provide an image processing method and an image processing device which, more effectively than the known solutions referred to above, eliminate high-frequency fixed noise. Furthermore, the method according to the invention can be attributed with the characteristics of being easy to implement, very efficient and stable, and also able to remove slowly varying spatio-temporal fixed pattern noise.

The purpose of the invention is achieved by an image processing method according to the first paragraph, characterized by

(a) spatially high-pass filtering the formed average;

(b) weighting the spatially high-pass filtered average pixel by pixel temporally with a metric of the difference between incoming saved frames;

(c) weighting the spatially high-pass filtered average with the value of an edge metric of incoming saved frames;

(d) storing the weighted, spatially high-pass filtered average as a cumulative image of fixed pattern noise and subtracting it from the video sequence.

The purpose of the invention is also achieved by an image processing device according to the first paragraph for implementing the image processing method, characterized in that the device comprises a camera with a detector, a motion detector, a memory for storing frames and a processor for processing stored frames.

The feature that the scene moves across the detector of a provided camera is intended to cover, among other things, that the camera can move, that the camera can be mounted on a moving platform, that the camera is zooming or that the camera is performing an autofocus process.

By utilizing the motion between the detector and the scene, the fixed pattern noise which remains fixed relative to the detector can be identified and effectively eliminated by steps (a) through (d) above, where, in addition to averaging and spatial high-pass filtering, the image processing comprises two separate image processing channels with separate weighting.

According to an advantageous embodiment of the method, the metric of the difference between incoming saved frames is determined using pixel-by-pixel averaging temporally. Alternatively, the metric of the difference between incoming saved frames can be determined temporally using maximum values pixel by pixel.

According to yet another advantageous embodiment of the method, the edge metric is determined based on local standard deviation, temporally and pixel by pixel. Alternatively, the edge metric can be determined based on a Tenengrad function applied temporally and pixel by pixel.

According to a further advantageous embodiment of the inventive method, the obtained edge metric is averaged pixel by pixel temporally.

According to a further advantageous embodiment of the inventive method, the edge metric obtained is determined temporally using maximum values pixel by pixel.

The image processing method is highly suited for removing fixed pattern noise in the infrared range and according to a suitable embodiment the method is characterized in that the incoming frames are captured within the infrared range.

The weighting metrics can, according to an embodiment of the method, be scaled down with respect to difference metrics and edge metrics, and it is particularly suggested that the weighting metrics are scaled down in intervals between one and zero depending on edge and differential values, the downscaling being increased in the case of high edge or differential values. Thus, in the case of high edge or differential values, downscaling can be set to a value near zero.

It is proposed that the image processing device for the implementation of the image processing method comprises a camera with a detector, a motion detector, a memory for storing frames and a processor for processing stored frames.

In particular, it is proposed to provide, in the image processing apparatus, scaling means for downscaling weighting metrics.

### BRIEF DESCRIPTION OF THE DRAWINGS

The invention will be further described below in exemplified form with reference to the accompanying drawings wherein:

FIG. 1 schematically illustrates, in the form of a block diagram, an image processing method according to the invention.

FIG. 2 schematically shows an example of an image processing device according to the invention.

### DETAILED DESCRIPTION OF THE EMBODIMENT

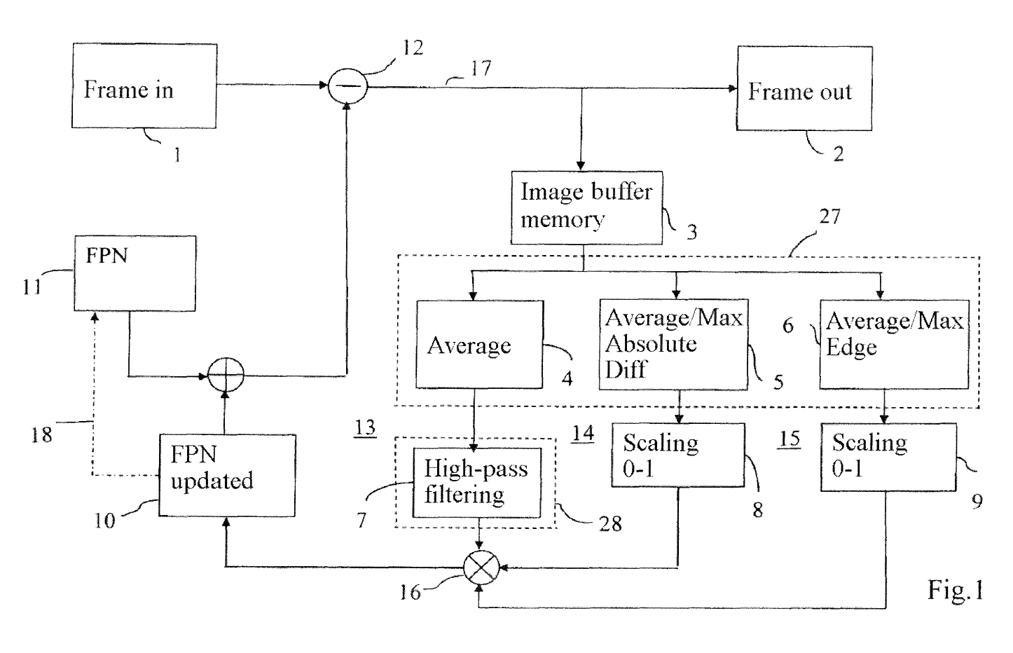

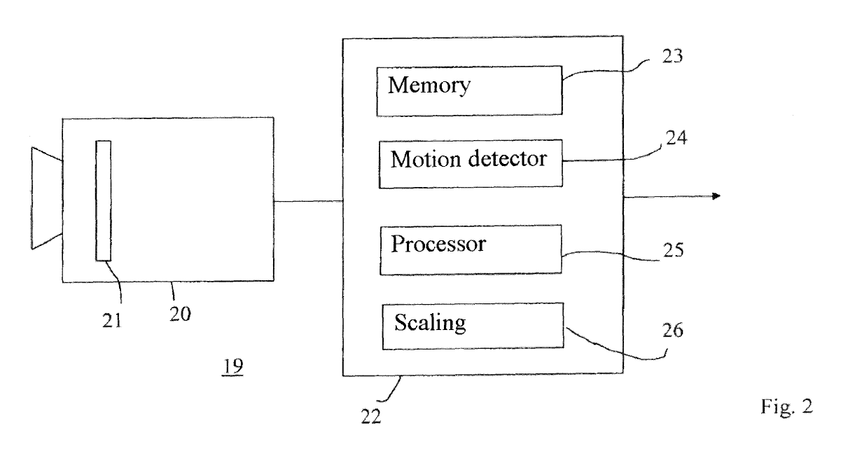

The image processing method is described below with reference to the block diagram shown in FIG. 1. Via an IR camera 20, for example, see FIG. 2, a video sequence arrives at Block 1. Block 1 delivers a sequence of frames. In addition to the scene depicted, these frames contain, among other things, interference in the form of fixed pattern noise, FPN, and related to the camera's detector. To eliminate the fixed pattern noise, it is desirable to identify the noise and to subtract, in a subtracter 12, the noise from the sequence of frames delivered by Block 1. At the output of subtracter 17 a sequence of frames is then obtained, frames more or less free from noise are obtained depending on how effectively the noise can be identified, and are added to a Block 2, which provides an outgoing sequence of frames.

To identify the noise, a process is proposed where the incoming sequence of frames is stored in an image buffer memory 3. The number of stored frames is limited and may be 16, for example. Moreover, frames are stored in sequence only where a relevant scene moves across the detector 21 of a provided camera 20; see FIG. 2.

The stored frames are processed in three channels: 13, 14, 15. In a first channel 13, the average of the sequence of stored frames is formed, Block 4, and then high-pass filtered spatially, Block 7.

In a second channel 14, a metric of the difference between the stored frames is produced, Block 5, which can then be scaled down, in Block 8. The metric of the difference between the stored frames can be determined in Block 5 by way of pixel-by-pixel averaging temporally. Alternatively, the metric of the difference between stored frames can be determined in Block 5 using maximum values pixel by pixel.

In a third channel 15, in Block 6, an edge metric for stored frames is determined, which can then be scaled down in Block 9. Block 6 can determine the edge metric based on the local standard deviation temporally and pixel by pixel. Alternatively, Block 6 can determine the edge metric based on a Tenengrad function applied temporally and pixel by pixel.

In the previous paragraph, two different models for edge determination were proposed. However, there exist various other known potential models, and the two proposed models do not rule out other models that may prove just as suitable.

After the edge metric has been determined in Block 6, also performed in said block is either an averaging of the edge metric pixel by pixel temporally or a determination of the edge metric temporally using maximum values pixel by pixel.

In FIG. 1, the temporal image processing has been marked with a dashed box 27, while a spatial image processing part has been marked with a dashed box 28.

In a subsequent step carried out on the outputs of channels 13, 14, 15, in a multiplier step 16, a weighting of the spatially high-pass filtered average from Block 4 is performed with a metric of the difference between stored frames from Block 8 and an edge metric of stored images from Block 9. From the multiplier step, an updated FPN image with fixed pattern noise is obtained, which, if the requirement for a current scene moving across the detector of a provided camera is met, is subtracted in the subtracter from the frames delivered in Block 1, while the updated FPN image is stored in a Block 11 via an implied dashed/dotted connection 18. In case there is no or little motion across the camera detector, however, no update is made of the FPN image, but the FPN image is retrieved from Block 11 as an FPN image previously stored therein. It may also be noted that Block 11 is preferably reset at startup.

For the implementation of the method described with reference to FIG. 1, FIG. 2 schematically shows an example of an image processing device 19. The device 19 comprises a camera part 20 with a detector 21. The video sequences captured by the camera detector are processed in an image processing part 22 according to the principles described with reference to FIG. 1. For this purpose, a memory part 23 is provided for storing the frames and FPN image. Further, there is a motion detector 24 for determining whether the requirements for motion between the capture of individual frames are met. A processor 25 processes stored frames for performing the included steps such as averaging, edge detection, high-pass filtering, etc. Also included is scaling equipment 26 for downscaling the weighting functions, and where downscaling can be externally controlled via, for example, actuators such as rotatable knobs (not shown).

The invention is not restricted to the exemplary methods and devices described above, but can be subject to modifications within the scope of the appended claims.

1. Image processing method for removing high-frequency fixed pattern noise from a video sequence (1), wherein a sequence of incoming frames is saved (3) when the relevant scene moves across the detector of a provided camera and a cumulative image of fixed pattern noise is formed from the saved image sequence, and wherein an average is formed from the sequence of incoming saved frames, characterized in
(a) spatially high-pass filtering the formed average;
(b) weighting the spatially high-pass filtered average pixel by pixel temporally with a metric of the difference between incoming saved frames;
(c) weighting the spatially high-pass filtered average with the value of an edge metric of incoming saved frames;
(d) storing the weighted, spatially high-pass filtered average as a cumulative image of fixed pattern noise and subtracting it from the video sequence.

2. Image processing method according to claim 1, characterized in that the metric of the difference between incoming saved frames is determined using pixel-by-pixel averaging temporally.

3. Image processing method according to claim 1, characterized in that the metric of the difference between incoming saved frames is temporally determined using maximum values pixel by pixel.

4. Image processing method according to claim 1, characterized in that the edge metric is determined based on local standard deviation temporally and pixel by pixel.

5. Image processing method according to claim 1, characterized in that the edge metric is determined based on a Tenengrad function applied temporally and pixel by pixel.

6. Image processing method according to claim 1, characterized in that the edge metric is averaged pixel by pixel temporally.

7. Image processing method according to claim 1, characterized in that the edge metric is determined temporally using maximum values pixel by pixel.

8. Image processing method according to claim 1, characterized in that the incoming frames are captured within the infrared range.

9. Image processing method according to claim 1, characterized in that the weighting metrics are scaled down in an interval between one and zero depending on edge and differential values, the downscaling being increased in the case of high edge or differential values.

10. Image processing device for implementing the image processing method according to claim 1, characterized in that the device comprises a camera with a detector, a motion detector, a memory for storing frames and a processor for processing stored frames according to the image processing method.

11. Image processing device according to claim 10, characterized in that scaling means are arranged for downscaling weighting metrics.
